(19) United States
(12) Patent Application Publication
(10) Pub. No.: US 2010/0274725 A1
(43) Pub. Date: Oct. 28, 2010

(54) AUTHORIZATION OF PAY USAGE OF ELECTRICITY BY NON-PREMISE MOBILE ELECTRICITY CONSUMERS

(75) Inventors: James D. Holbery, Kirkland, WA (US); Van L. Eden, Hansville, WA (US)

Correspondence Address: SCHWABE, WILLIAMSON & WYATT, P.C., 1420 FIFTH, SUITE 3400, SEATTLE, WA, 98101-4010, US

(73) Assignee: GRID MOBILITY LLC, Kirkland, WA (US)

(21) Appl. No.: 12/769,574

(22) Filed: Apr. 28, 2010

Related U.S. Application Data
(60) Provisional application No. 61/173,495, filed on Apr. 28, 2009.

(51) Int. Cl. G06Q 50/00; G06Q 20/00; G06Q 40/00; G06Q 30/00; H04L 9/08

(52) U.S. Cl. 705/63; 705/40; 705/34; 705/71

(57) ABSTRACT

Embodiments of methods and apparatuses for authorizing a non-premise mobile (NPM) paying consumer to consume electricity from an electrical outlet are disclosed herein. In various embodiments, the electrical outlet has an associated outlet identifier, but limited, at most local communication capability. In various embodiments, a computing device may be configured to receive from a communication device associated with the NPM electricity consumer, a request to consume electricity through the electrical outlet. The request may include the outlet identifier, a payment identifier associated with the NPM electricity consumer, and a transaction quantity. Additionally, the computing device may be configured to generate and transmit, on successful arrangement for at least some payment, an authorization token authorizing a limited or unlimited consumption of electricity through the electrical outlet commensurate with the payment arranged, to the communication device.

### RELATED APPLICATIONS

The present application is a non-provisional application of, and claims priority to the U.S. Provisional Application 61/173,495, entitled “A method for performing secure transactions between a user and a device using only a communication channel managed by the user,” filed Apr. 28, 2009. The specification of the provisional application is hereby incorporated by reference, to the extent they are consistent with the present specification.

### TECHNICAL FIELD

Embodiments of the present disclosure relate to the field of electricity generation, distribution and consumption, more specifically, to methods and apparatuses for authorizing a non-premise mobile paying electricity consumer to consume a limited or unlimited quantity of electricity from an electrical outlet with none, or at most local communication capability.

### BACKGROUND

With increased concern over climate change, cost of fossil fuels, and so forth, there is an increase in interest in switching to use electricity for energy, e.g., the increased popularity of electric or hybrid vehicles. Also, there is an increased interest in generating and consuming more electricity generated from renewable sources, such as, wind, solar, hydro, bio mass, geothermal, and nuclear (which for the purpose of this application, are all considered “renewable sources”). The switching, as well as generating/consuming more electricity from renewable sources have been relatively slow, because in part the lack of mechanisms for collecting payment from non-premise mobile paying consumers for their consumption of electricity.

### SUMMARY

Embodiments of methods and apparatuses for authorizing a non-premise mobile (NPM) paying consumer to consume a limited or unlimited quantity of electricity from an electrical outlet are disclosed herein. In various embodiments, the electrical outlet has an associated outlet identifier, but none or at most local communication capability. In various embodiments, a computing device of a Service Provider may be configured to receive from a communication device associated with the NPM electricity consumer, a request to consume electricity through the electrical outlet. The request may include the outlet identifier, a payment identifier associated with the NPM electricity consumer, and a transaction quantity. Additionally, the computing device may be further configured to arrange, in response, for payment for the transaction quantity by the NPM electricity consumer to a premise owner with financial responsibility to an electricity generating entity for electricity consumed through the electrical outlet, using at least the provided payment identifier. Further, the computing device may be configured to generate and transmit, on successful arrangement for payment for the requested transaction quantity (or a minimum transaction quantity), an authorization token authorizing a limited or unlimited consumption of electricity through the electrical outlet commensurate with the payment arranged, to the communication device.

In various embodiments, the payment identifier may be an account the NPM electricity consumer has with the Service Provider. In various embodiments, the payment identifier may a subscriber identifier associated with a subscription of the NPM electricity consumer for communication service, e.g., mobile telephony service. In various embodiments, the payment identifier may be a bank account number or a credit card number associated with an account of the NPM electricity consumer with a financial institution.

In various embodiments, the authorization token may include a consumption limit (commensurate with the amount of payment secured) and/or a secret key, capable of being verified by the electrical outlet. In various embodiments, the secret key may be a key selected from a pool of secret keys in possession by both the computing device and the electrical outlet. In various embodiments, the secret key may be a symmetric key capable of being generated by both the computing device and the electrical outlet independently, but symmetrically. In various embodiments, generating and transmitting may include generating the authentication token, encrypting the authentication token, and transmitting the authentication token in an encrypted form, capable of being decrypted by the electrical outlet.

### BRIEF DESCRIPTION OF THE DRAWINGS

Embodiments of the present disclosure will be described by way of exemplary embodiments, but not limitations, illustrated in the accompanying drawings in which like references denote similar elements, and in which:

FIG. 1 illustrates a network overview of the apparatuses of the present disclosure, in accordance with various embodiments;

FIG. 2 illustrates an operational overview of the methods of the present disclosure, in accordance with various embodiments;

FIG. 3 illustrates an example controller and outlet arrangement, suitable for use to practice aspects of the present disclosure, in accordance with various embodiments; and

FIG. 4 illustrates an example computer system, suitable for use to practice aspects of the present disclosure, in accordance with various embodiments.

### DETAILED DESCRIPTION OF ILLUSTRATIVE EMBODIMENTS

Illustrative embodiments of the present disclosure include but are not limited to methods and apparatuses for authorizing a non-premise mobile (NPM) paying consumer to consume a limited or unlimited quantity of electricity from an electrical outlet. Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C) or (A, B and C).” The phrase “(A) B” means “(B) or (A B)”, that is, A is optional.

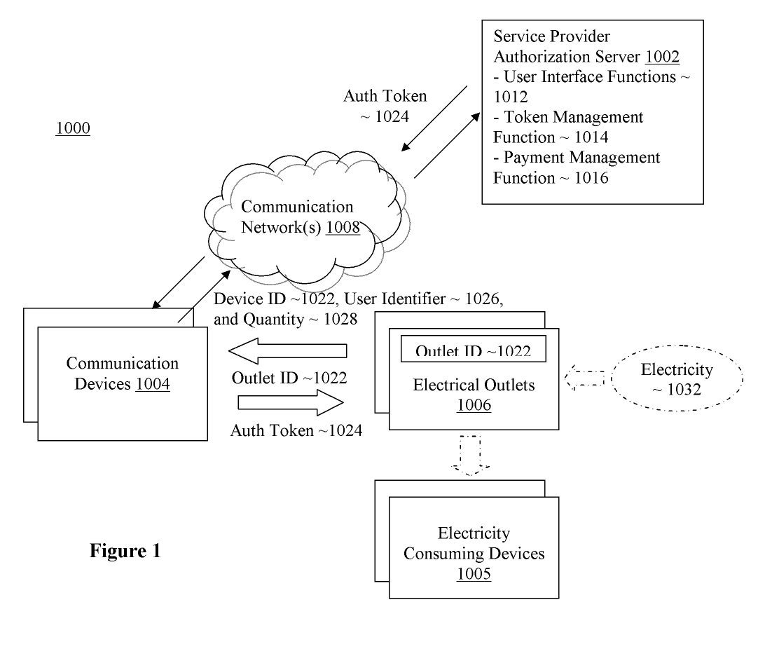

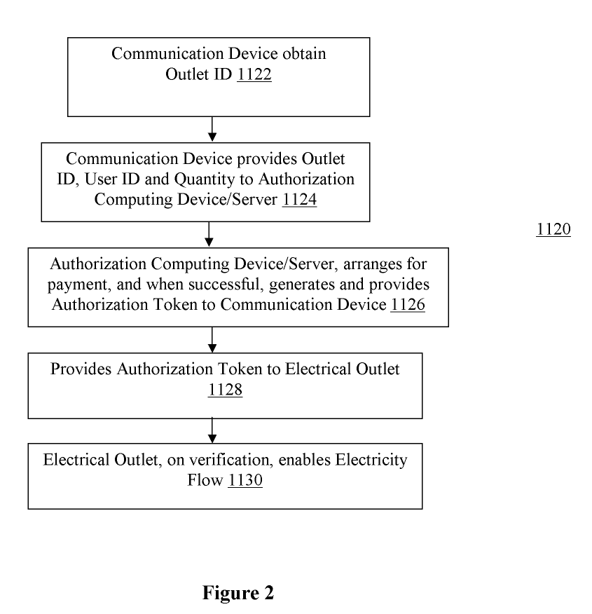

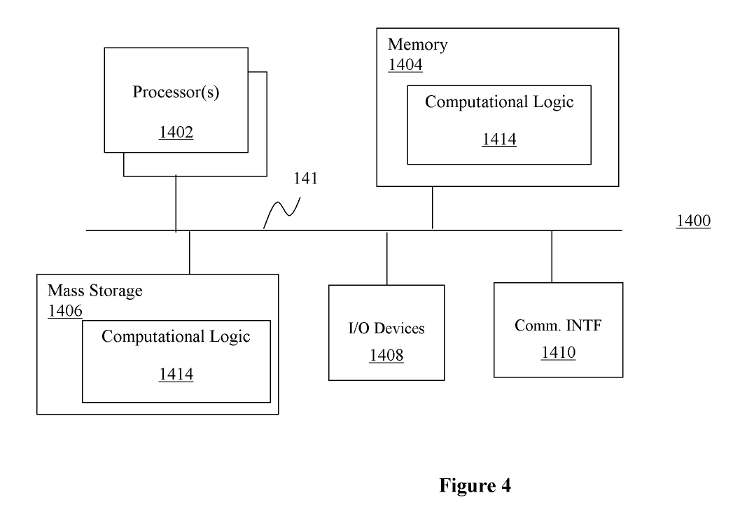

FIG. 1 illustrates a network overview of the apparatuses of the present disclosure, in accordance with various embodiments. As illustrated, computing device or devices 1002 of a Service Provider, incorporated with the teachings of the present disclosure, and communication devices 1004 associated with NPM electricity consumers, may be coupled to each other via one or more communication networks 1008. In various embodiments, computing device or devices (hereinafter simply “device”) 1002 may be configured with User Interface (UI) function 1012, Token Management (TM) function 1014, and Payment Management (PM) function 1016, to be described more fully below, in particular with references to FIGS. 2 and 4.

Example of communication devices 1004 associated with NPM electricity consumers may include, but are not limited to, computers, mobile phones, and the like. Communication networks 1008 may include one or more public and/or private communication networks, including but are not limited to the Internet, Broadband and/or Cellular communication offered by communication carriers, and/or private enterprise networks.

Also illustrated are electrical outlets 1006 and electricity consuming devices 1005, which may be electrically coupled to each other. In various embodiments, electrical outlets 1006 have respective associated outlet identifiers 1022, which may be used by communication devices 1004 to obtain appropriate authorization tokens 1024, to which electrical outlets 1006 may respond and allow a limited or unlimited quantity of electricity 1032 to be consumed through electrical outlets 1006.

In various embodiments, outlet identifiers 1022 may be tags physically disposed on respective external surfaces, or images rendered on respective displays, thereby visible to the NPM electricity consumers of communication devices 1004. Tags and/or images may include alphanumeric outlet identifiers, bar codes, and/or pictograms. In various embodiments, the outlet identifies 1022 may be provided to communication devices 1104, by the NPM electrical consumers inputting the outlet identifiers 1022 via an input user interface of communication devices 1104, such as a keyboard (physical or virtual), a scanner and so forth.

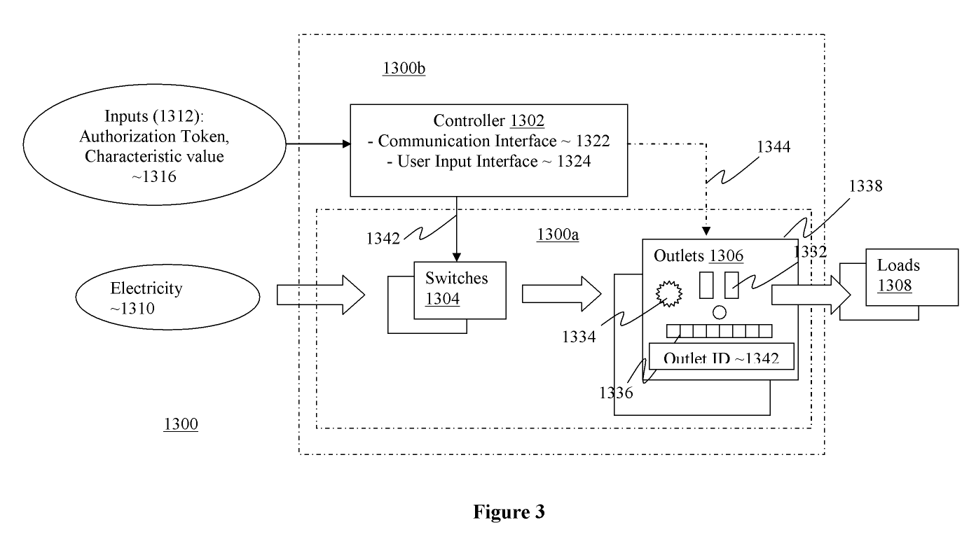

In various embodiments, electrical outlets 1006 may be endowed with none or at most local communication capability, e.g., with a communication reach of only conventional personal communication techniques, such as Infrared, Bluetooth, and so forth. For these embodiments, outlet identifiers 1022 may be wirelessly transmitted from electrical outlets 1006 to communication devices 1004. For these embodiments, electrical outlets 1006 may periodically broadcast their outlet identifiers 1022, or responsively provide them upon receipt of discovery inquiries from communication devices 1004. Examples of various outlets particularly suitable for practicing various aspects of the present disclosure will be described later with references to FIG. 3.

Electricity consuming devices 1005 are intended to represent a broad range of devices associated with electricity consumption, including, but are not limited to, personal digital assistants (PDA), mobile phones, laptop computers, transportation vehicles, boats, and so forth.

Referring now also to FIG. 2, wherein an overview of various methods of the present disclosure, in accordance with various embodiments, is shown. As illustrated, in various embodiments, a method of the present disclosure may start in block 1122, with communication device 1004 obtaining an outlet identifier 1022 associated with an electrical outlet 1006. In various embodiments, as described earlier, communication device 1004 may obtain outlet identifier 1022 from the NPM electricity consumer, with the NPM electricity consumer entering or otherwise acquiring outlet identifier 1022 into communication device 1004, or from electrical outlet 1006 directly, with electrical outlet 1006 equipped with local wireless communication capability directly providing outlet identifier 1022 to communication device 1004.

In various embodiments, from block 1122, the method may proceed to block 1124, where communication device 1004 may transmit a request to consume electricity through electrical outlet 1006, to user interface (UI) function 1012 of computing device/server 1002. In various embodiments, the request may be transmitted in any one of a number of wide area communication protocols and signaling methods, such as, but not limited to Short Messaging Services (SMS), Transmission Control Protocol/Internet Protocol (TCP/IP), Asynchronous Transfer Mode (ATM), Asymmetric Digital Subscriber Line (ADSL), Worldwide Interoperability for Microwave Access (WiMax), and Synchronous Optical Network (SONET), and so forth.

In various embodiments, the request may include outlet identifier 1022, a payment identifier 1026 associated with the NPM electricity consumer, and a quantity 1028 indicating an amount of electricity desired. In various embodiments, payment identifier 1026 may be an account identifier associated with an account the NPM electricity consumer has with the Service Provider associated with computing device/server 1002. In various embodiments, payment identifier 1026 may be a subscriber identifier associated with a subscription of the NPM electricity consumer for communication service, e.g., mobile telephony service, with a communication carrier, a bank account number or a credit card number associated with an account of the NPM electricity consumer with a financial institution.

In various embodiments, from block 1124, the method may proceed to block 1126, where UI function 1012 may, in response, invoke payment management (PM) function 1014 to arrange for payment for the transaction quantity by the NPM electricity consumer to a premise owner with financial responsibility to an electricity generating entity for electricity consumed through the electrical outlet, using at least the provided payment identifier 1026. The arrangement for payment may include debiting the NPM electrical consumer with the Service Provider, making arrangement with a communication carrier to debit the NPM electrical consumer's communication service account, or making arrangement with a financial institution to debit the NPM electrical consumer's bank or credit card account. The arrangement for payment may further include credit an account associated with the premise owner of the electrical outlet 1006. In various embodiments, the premise owner may of course be an electricity generating entity or even the Service Provider itself.

On successful arrangement for payment for the requested quantity (or a minimum quantity), PM function 1016 may invoke TM function 1014 of computing device/server 1002 to generate an authorization token authorizing consumption of the desired amount of electricity through the electrical outlet. In turn, TM function 1014 of computing device 1002 may invoke UI function 1012 again to transmit the authorization token 1024 to communication device 1004.

In various embodiments, authorization token 1024 may include an indication of authorized unlimited consumption, or an authorized consumption limit (commensurate with the amount of payment secured) and/or a secret key, capable of being verified by electrical outlet 1006. In various embodiments, the authorized consumption limit may be represented in the form of a monetary amount (e.g., x dollars), a duration of usage in term time (e.g., y minutes), and/or an energy form (e.g., z kilowatts). In various embodiments, the secret key may be one of a pool of one-time use keys both computing device/server 1002 and electrical outlet 1006 possess. The pool of one-time use keys may be periodically provided to or symmetrically synthesized by both computing device/server 1002 and electrical outlet 1006. For these embodiments, upon generation, TM function 1014 may delete, invalidate or otherwise remove the generated secret key from the pool of secret keys. In various embodiments, the secret key may be a symmetric key both computing device/server 1002 and electrical outlet 1006 can independently, but symmetrically generate. The symmetric key may be time dependent and having short half-life.

In various embodiments, generating by TM function 1014 may include generating and encrypting authorization token 1024 by TM function 1014, in an encrypted form capable of being decrypted by electrical outlet 1006, using an encryption/decryption key or key pair known to both computing device/server 1002 and electrical outlet 1006. In various embodiments, the encryption/decryption key pair may be a public/private key pair.

In various embodiments, UI function 1012 may transmit the authorization token from computing device/server 1002 to communication device 1004 using the same or a different communication protocol or method used to communicate the consumption request.

In various embodiments, from block 1126, the method may proceed to block 1128, wherein authorization token 1024 may be provide to electrical outlet 1006. In various embodiments, as described earlier, electrical outlet 1006 may include a user input interface, through which NPM electricity consumer may enter authorization token 1024. In various embodiments, electrical outlet 1006 may include a limited, e.g., local communication interface, through which communication device 1004 may directly provide electrical outlet 1006 with authorization token 1024.

In various embodiments, from block 1128, the method may proceed to block 1130, where in response to received authorization token 1024, electrical outlet 1006, on verification of a received authorization 1024, may allow an appropriate limited or unlimited consumption of electricity by an electricity consuming device 1005. In embodiments where authorization token 1024 is selected from a pool of one-time use keys both computing device/server 1002 and electrical outlet 1006 possess, electrical outlet 1006 may delete, invalidate or otherwise remove the used secret key from the pool of available secret keys.

Before proceeding to further describing the present disclosure, it should be noted, in general, there is no order dependency between the issuance of authorization tokens and the usage of authorization tokens to consume electricity through the applicable electrical outlets. In other words, a first NPM electricity consumer may obtain a first authorization token for an electrical outlet before a second NPM electricity consumer obtaining a second authorization token for the same electrical outlet, but uses the first authorization token to consume electricity through the electrical outlet, after the second NPM electricity consumer uses the later obtained second authorization token. However, if desirable, embodiments of methods and apparatuses practicing the present disclosure may impose such an order.

Further, it should be noted that while for ease of understanding, the operations of computing device/server 1002 have been described in terms of UI function 1012, TM function 1014, and PM function 1016, in alternate embodiments, the capability for performing the operations may be implemented using more or less functions.

FIG. 3 illustrates an example outlet arrangement, suitable for receiving the signal, and in response, adjusting the availability of electricity through outlet, thereby affecting the consumption of electricity by load electrically coupled to the outlet, in accordance with various embodiments. In various embodiments, a system for controlling consumption of electricity may be formed using a number of the arrangements and a remote control server. The outlet arrangement 1300, and a system formed using a number of arrangements 1300 and a remote control server are the subjects of a co-pending application, number (to be assigned), entitled “Outlet Arrangement and System,” contemporaneously filed (attorney docket reference: 120814-175549).

As shown, in various embodiments, electrical outlet arrangement 1300 may include one or more electrical outlets 1306 and one or more switches 1304 coupled with each other. Each electrical outlet 1306 may be provided to accept electrical coupling from a corresponding load 1308, to consume electricity flow provided to the electrical outlet when electricity flow 1310 to the electrical outlet is enabled. The one or more electrical outlets 1306 may be electrically coupled with one or more switches 1304 configured to enable or disenable electricity flow 1310 to the one or more electrical outlets 1306, in response to the control of local controller 1302 and/or a remote control server (not shown). Local controller 1302 may be communicatively coupled 1342 with the one or more switches 1304, and configured to control the one or more switches 1304 to enable or disable electricity flow 1310 in response to an input 1312, e.g., an authorization token 1314, provided to local controller 1302 by a user or the remote control server. In various embodiments, the remote control server may control a number of local controllers 1302 located at a number of dispersed locations, via e.g., a wide area network (not shown).

In various embodiments, local controller 1032 may include storage configured to store a pool of available secret keys. In various embodiments, local controller 1032 may include circuitry and/or logic configured to periodically synthesize the pool of available secret keys, independently, but symmetrically with computing device 1002. In still other embodiments, local controller 1032 may include circuitry and/or logic configured to generate a symmetry key, in particular, a time dependent symmetric key with a short half-life. In various embodiments, local controller 1032 may include circuitry and/or logic configured to decrypt an encrypted authorization token, in particular, through a public/private key pair.

In various embodiments, each electrical outlet 1306 may include a socket 1332 configured to accept electrical coupling from a corresponding load 1308 for consumption of electricity flow provided to the electrical outlet, when provision of electricity flow is enabled. Each or a group of electrical outlets 1306 may be provided with a visual indicator 1334, e.g., a green or red light emitting device (LED), configured to provide visual indication to the NPM electricity consumer that consumption of electricity flow 1310 through the electrical outlet(s) 106 is enabled or disabled.

Additionally, in various embodiments, inputs 1312 may include a characteristic value 1316 denoting e.g., an amount of the current electricity flow is being generated from renewable source or sources, or an amount of the current electricity flow is being generated from fossil fuel. For these embodiments, each or a group of electrical outlets 1306 may be further provided with a display 1336, e.g., an array of multi-color LED, including green LED, to display the percentage of the electricity flow being generated using one or more renewable sources or black LED, to display the percentage of the electricity flow being generated using fossil fuel, or both.

In various embodiments, visual indicator 1334 and display 1336 may be disposed on an exterior surface of a housing 1338 configured to house one or more of electrical outlets 1306. In various embodiments, a timer (not shown) may also be integrated to the electrical outlet 1306. In various embodiments, each or a group of outlets 1306 may include a communication interface (not shown) coupling visual indicator 1334 and display 1336 to controller 1302, enabling controller 1302 to control visual indicator 1334 and display 1336. Communication interface may be configured for wired or wireless communication with controller 1302.

In various embodiments, as described earlier, communication interface 1322 may include a wide range local communication interfaces, such as, but are not limited to, Bluetooth, infrared and so forth.

FIG. 4 illustrates an example computer system or computing device, suitable for use to practice aspects of the present disclosure, in particular, devices 1002, in accordance with various embodiments. As shown, exemplary computing system or computing device 1400 includes one or more processors 1402 and system memory 1404. Additionally, system/device 1400 may include mass storage devices 1406 (such as diskette, hard drive, CDROM and so forth), input/output devices 1408 (such as keyboard, cursor control and so forth) and communication interfaces 1410 (such as network interface cards, modems and so forth). The elements may be coupled to each other via system bus 1412, which represents one or more buses. In the case of multiple buses, the buses may be bridged by one or more bus bridges (not shown).

Each of these elements performs its conventional functions known in the art. In particular, system memory 1404 and mass storage 1406 may be employed to store a working copy and a permanent copy of the programming instructions (computing logic 1414) and/or data, implementing the teachings of the present disclosure (e.g., earlier described UI function 1012, TM function 1014 and PM function 1016). The programming instructions may be instructions of any one of a number of known or to be designed languages, including but are not limited to C, C++, Perl, Java, Javascript, XML, HTML and so forth. All or a portion of the permanent copy of the programming instructions/data may be loaded into mass storage 1406 in the factory, in the field (via a distribution medium) or through communication interface 1410 (from a distribution server (not shown)).

The constitution of elements 1402-1412 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present disclosure. This application is intended to cover any adaptations or variations of the embodiments discussed herein. Therefore, it is manifestly intended that this disclosure be limited only by the claims and the equivalents thereof.

What is claimed is:

1. A method comprising:
receiving, by a computing device, from a communication device associated with a non-premise mobile (NPM) electricity consumer, a request to consume electricity through an electrical outlet, wherein the request includes an outlet identifier associated with the electrical outlet, a payment identifier associated with the NPM electricity consumer, and a transaction quantity;
arranging, by the computing device, using the payment identifier, for payment for the transaction quantity by the NPM electricity consumer, to a premise owner with financial responsibility to an electricity generating entity for electricity consumed through the electrical outlet; and
generating and transmitting, by the computing device, to the communication device, on successful arrangement for at least some payment, an authorization token authorizing a limited or unlimited consumption of electricity through the electrical outlet commensurate with the payment arranged.

2. The method of claim 1, wherein the payment identifier comprises a subscriber identifier associated with a subscription of the NPM electricity consumer for communication service.

3. The method of claim 1, wherein the payment identifier comprises an account identifier identifying a bank account or a credit card account associated with an account of the NPM electricity consumer with a financial institution.

4. The method of claim 1, wherein the authorization token comprises an authorized consumption limit expressed in a form selected from a monetary unit form, a time duration form or an energy unit form.

5. The method of claim 1, wherein the authorization token comprises a secret key capable of being verified by the electrical outlet.

6. The method of claim 1, wherein generating and transmitting comprise generating the authentication token, encrypting the authentication token, and transmitting the authentication token in an encrypted form, capable of being decrypted by the electrical outlet.

7. An apparatus comprising:
a processor;
a non-transitory computer-readable storage medium coupled with the processor; and
a plurality of instructions stored in the storage medium, and configured to enable the apparatus, in response to execution of the instructions by the processor, to:
receive from a communication device associated with a non-premise mobile (NPM) electricity consumer, a request to consume electricity through an electrical outlet, wherein the request includes an outlet identifier associated with the electrical outlet, a payment identifier associated with the NPM electricity consumer, and a transaction quantity;
arrange, using the payment identifier, for payment for the transaction quantity by the NPM electricity consumer to a premise owner with financial responsibility to an electricity generating entity for electricity consumed through the electrical outlet; and
generate and transmit to the communication device, on successful arrangement for at least some payment, an authorization token authorizing a limited or unlimited consumption of electricity through the electrical outlet commensurate with the payment arranged.

8. The apparatus of claim 7, wherein the payment identifier comprises a subscriber identifier associated with a subscription of the NPM electricity consumer for communication service.

9. The apparatus of claim 7, wherein the payment identifier comprises an account identifier identifying a bank account or a credit card account associated with an account of the NPM electricity consumer with a financial institution.

10. The apparatus of claim 7, wherein the authorization token comprises an authorized consumption limit expressed in a form selected from a monetary unit form, a time duration form or an energy unit form.

11. The apparatus of claim 7, wherein the authorization token comprises a secret key capable of being verified by the electrical outlet.

12. The apparatus of claim 7, wherein the instructions are configured to enable the apparatus, in response to execution of the instructions by the processor, to generate the authentication token, encrypt the authentication token, and transmit the authentication token in an encrypted form, capable of being decrypted by the electrical outlet.

13. An article of manufacture, comprising:
a non-transitory computer-readable storage medium; and
a plurality of instructions stored in the storage medium, and configured to enable an apparatus, in response to execution of the instructions by the apparatus, to perform operations including:
receiving from a communication device associated with a non-premise mobile (NPM) electricity consumer, a request to consume electricity through an electrical outlet, wherein the request includes an outlet identifier associated with the electrical outlet, a payment identifier associated with the NPM electricity consumer, and a transaction quantity;
arranging, using the payment identifier, for payment for the transaction quantity by the NPM electricity consumer to a premise owner with financial responsibility to an electricity generating entity for electricity consumed through the electrical outlet; and
generating and transmitting to the communication device, on successful arrangement for at least some payment, an authorization token authorizing a limited or unlimited consumption of electricity through the electrical outlet commensurate with the payment arranged.

14. The article of claim 13, wherein the payment identifier comprises a subscriber identifier associated with a subscription of the NPM electricity consumer for communication service.

15. The article of claim 13, wherein the payment identifier comprises an account identifier identifying a bank account or a credit card account associated with an account of the NPM electricity consumer with a financial institution.

16. The article of claim 13, wherein the authorization token comprises an authorized consumption limit expressed in a form selected from a monetary unit form, a time duration form or an energy unit form.

17. The article of claim 13, wherein the authorization token comprises a secret key capable of being verified by the electrical outlet.

18. The article of claim 13, wherein the instructions are configured to enable the apparatus, in response to execution of the instructions by the processor, to generate the authentication token, encrypt the authentication token, and transmit the authentication token in an encrypted form, capable of being decrypted by the electrical outlet.
